(19) United States
(12) Patent Application Publication
(10) Pub. No.: US 2008/0226156 A1
(43) Pub. Date: Sep. 18, 2008

(54) Defect detection apparatus and defect detection method

(75) Inventor: Yoshinari Ota, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/069,510

(22) Filed: Feb. 11, 2008

(30) Foreign Application Priority Data
Feb. 19, 2007 (JP) P2007-038214

(51) Int. Cl. G06K 9/03

(52) U.S. Cl. 382/141

(57) ABSTRACT

A primary defect detecting section performs a primary defect detection process for detecting a severe defect of more than a predetermined size on an inspection object. A secondary defect detecting section performs a secondary defect detection process for detecting a defect on the inspection object using image data of the inspection object. A process controller omits the secondary defect detection process upon detection of the severe defect in the primary defect detection process before starting the secondary defect detection process, or stops the secondary defect detection process upon detection of the severe defect in the primary defect detection process after starting the secondary defect detection process.

### BACKGROUND OF THE INVENTION

1. Technical Field

The present invention relates to an apparatus and a method for detecting a defect on a surface of an inspection object, such as a semiconductor wafer used in a production process of a semiconductor device, and a glass substrate used in a production process of a liquid crystal display.

This Application claims priority of Japanese Patent Application No. 2007-38214, filed on Feb. 19, 2007, the disclosure of which is incorporated herein by reference in its entirety.

2. Background Art

In a production process of semiconductor devices, the semiconductor devices are inspected for defects including film nonuniformity, foreign substances, dirt, and cracks on a resist applied onto a substrate such as a semiconductor wafer. Since image processing of detected defects for the entire wafer surface usually takes a long time, there is a demand for a defect detection system which may be performed in a short time.

For example, Japanese Patent Application Laid-Open No. 9-64130 discloses a defect inspection method performed in a short time. In the disclosed method, a CCD linear sensor scans multiple chips of a semiconductor wafer at a time while carrying the wafer on a wafer conveyer, obtains image information of the multiple chips, and outputs signals as image data which are then stored temporarily in a buffer memory. A process device compares the image data of each chip output from the buffer memory with a standard pattern in a defect analysis process so as to detect any defects in each chip.

However, in such conventional inspection systems, all of the given processes are carried out in sequence. If a severe defect of more than a predetermined size is detected in near the end of inspection and causes the production process to discontinue, the image processing for defect detection until then becomes useless, thereby causing considerable detection time.

### SUMMARY OF THE INVENTION

In view of the aforementioned, an object of the invention is to provide a defect detection apparatus and a defect detection method which may reduce inspection time upon detection of a severe defect over a given size.

To achieve the above object, an aspect of the invention is a defect detection apparatus including: a primary defect detecting device which performs a primary defect detection process for detecting a severe defect of more than a predetermined size on an inspection object; a secondary defect detecting device which performs a secondary defect detection process for detecting a defect on the inspection object using image data of the inspection object; and a process control device for controlling performance of the primary defect detection process and the secondary defect detection process, wherein the process control device omits the secondary defect detection process upon detection of the severe defect in the primary defect detection process before starting the secondary defect detection process, or stops the secondary defect detection process upon detection of the severe defect in the primary defect detection process after starting the secondary defect detection process.

Another aspect of the invention is a defect detection method for performing a primary defect detection process for detecting a severe defect of more than a predetermined size on an inspection object, and a secondary defect detection process for detecting a defect on the inspection object using image data of the inspection object, wherein the secondary defect detection process is omitted upon detection of the severe defect in the primary defect detection process before starting the secondary defect detection process, or the secondary defect detection process is stopped upon detection of the severe defect in the primary defect detection process after starting the secondary defect detection process.

According to the invention, upon detection of a severe defect which may affect post processes in the primary defect detection process, the secondary defect detection process is omitted or stopped. In this manner, the inspection time may be reduced in a case with a severe defect over a given size.

The above and other objects, operations, advantageous effects of the invention will become apparent to those skilled in the art from the accompanying drawing and description of the embodiments of the invention.

### BRIEF DESCRIPTION OF THE DRAWINGS

FIG. 1 is a structural block diagram of a substrate inspection system according to a first embodiment of the invention.

FIG. 2 is a flow diagram illustrating an operation procedure of the substrate inspection system according to the first embodiment of the invention.

FIG. 3 is a reference diagram of a setting screen according to the first embodiment of the invention.

FIG. 4 is a reference diagram of a non-defective image shown in an overlaid manner according to the first embodiment of the invention.

FIG. 5 is a flow diagram illustrating a procedure of a secondary defect detection process according to the first embodiment of the invention.

FIG. 6 is a structural block diagram of a substrate inspection system according to a second embodiment of the invention.

FIG. 7 is a flow diagram illustrating an operation procedure of the substrate inspection system according to the second embodiment of the invention.

FIG. 8 is a flow diagram illustrating an operation procedure of the substrate inspection system according to a third embodiment of the invention.

FIG. 9 is a reference diagram of a setting screen according to the third embodiment of the invention.

FIG. 10 is a reference diagram of a setting screen according to the third embodiment of the invention.

FIG. 11 is a flow diagram illustrating a procedure of a secondary defect detection process in the third embodiment of the invention.

FIG. 12 is a flow diagram illustrating an operation procedure of a substrate inspection system according to a fourth embodiment of the invention.

FIG. 13 is a reference diagram of a setting screen according to the fourth embodiment of the invention.

FIG. 14 is a reference diagram of a screen showing a wafer photographed from an angled direction according to the fourth embodiment of the invention.

FIG. 15 is a flow diagram illustrating a procedure of an image conversion process according to the fourth embodiment of the invention.

FIG. 16 is a reference diagram illustrating a method of reducing the pixel count according to the fourth embodiment of the invention.

### BRIEF DESCRIPTION OF THE REFERENCE NUMERALS

1: substrate inspection system
2: device controller (photographing condition controlling device)
3: main computer
27: H/W controller (photographing condition controlling device)
34: image operating section (pixel count reducing device, area division device)
35: defect detection data storage section (memory device)
36: primary defect detecting section (primary defect detecting device)
37: secondary defect detecting section (secondary defect detecting device)
38: process controller (process control device)

### DETAILED DESCRIPTION OF THE INVENTION

Referring now to the drawings, embodiments of the invention will be described. However, the invention is not limited to these embodiments.

### First Embodiment

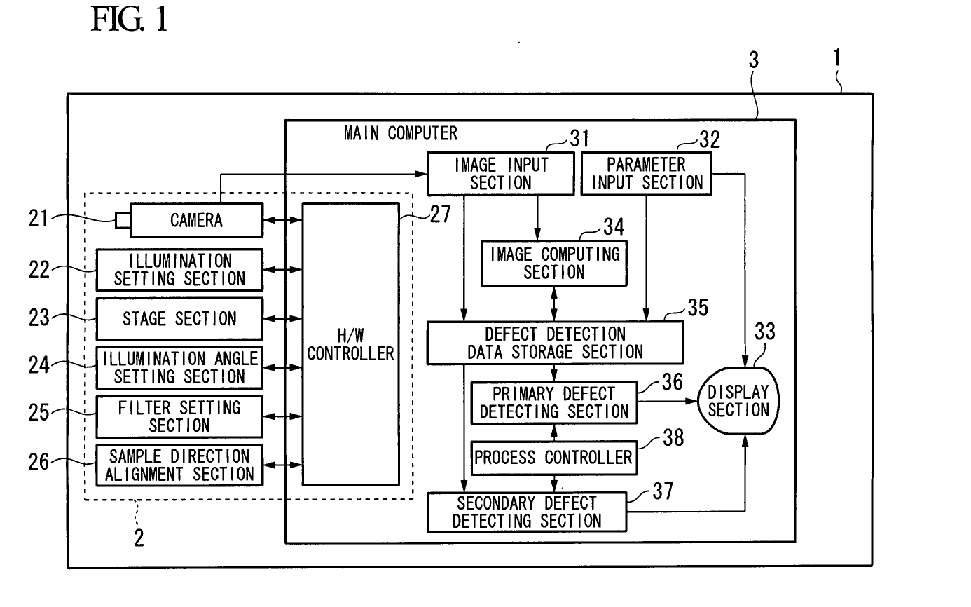

A first embodiment of the invention will be described. FIG. 1 shows a structure of a substrate inspection system according to the first embodiment. A substrate inspection system 1 in FIG. 1 includes a device controller 2 and a main computer 3 (altogether corresponding to a defect detection apparatus of the invention). The substrate inspection system 1 is used in a defect inspection method which irradiates a semiconductor wafer (hereafter referred to simply as “wafer”) to be inspected (i.e., a sample or test body) with light, photographs the light reflected from, scattered from, diffracted through, and transmitted through the wafer, and processes the photographed images.

A camera in the device controller 2 includes image sensors such as charge coupled devices (CCDs) for photographing a wafer. The camera 21 is not limited to a CCD camera. Rather, two-dimensional images may be obtained by using sensors such as a photomultiplier for detecting light from samples or a photo detector (PD) for laser beams, and scanners such as a galvanomirror.

Instead of providing a sensor in the substrate inspection system 1, image data obtained with a sensor may be input from a network-connected image file server, or may be input from a removable media. That is, images are obtained by photographing, stored in an unillustrated storage, and inspected in accordance with the invention in a single substrate inspection system.

An illumination setting section 22 is for setting the brightness of light which is irradiating the wafer. A Stage section 23 includes a stage for fixing the wafer. An illumination angle setting section 24 is for setting the angle of the light which is irradiating the wafer.

A filter setting section 25 sets a filter used to adjust wavelengths and polarization conditions of the light output from the wafer. A sample direction alignment section 26 is for aligning the wafer and adjusting the position of the wafer in the X, Y and θ directions. An H/W controller 27 (hardware controller) controls photographing conditions of camera 21, stage movement, filter selection, light angle setting, brightness setting, and the like based on preset values (control values) for more effective inspection.

In the main computer 3, an image input section 31 obtains input image corresponding to each pixel of the camera 21 (the image size is set to M×N, where M and N are integers), and stores brightness data of a pixel position (i, j) in a two-dimensional array Iᵢₙ(i, j) (i and j are integers which satisfy 1≦I≦M and 1≦j≦N). The image size is set to the size of the image input into the main computer 3 in the image input section 31.

In the subsequent image processing, either the entire image photographed with the camera 21 or a part thereof may be processed. Only a part of the entire image may be used in the subsequent processes, or alternatively, the processes described below may be repeated for a number of the divided images so that the entire image may be used in the subsequent processing.

A parameter input section 32 includes an input device for operator input. Referring to a display screen in a display section 33, the operator sets the inspection area through the parameter input section 32. The operator also inputs a threshold used in the primary and secondary defect detection processes described later. Information regarding the set inspection area or the set threshold is stored in the defect detection data storage section 35. The parameter input section 32 is not limited to common input device for personal computers (PC) such as a mouse or a keyboard. Rather, parameters may be input through a touch panel, also serving as a display device, or input from another PC network-connected to the main computer 3.

The display section 33 displays a setting screen used for setting inspection areas, thresholds, and the like. In some embodiments, the results of the primary and secondary defect detection processes may be displayed on the display section 33. The display section 33 is not limited to common PC display devices including a CRT and a liquid crystal display monitor. The main computer 3 may include WEB service software and a GUI service program, and the setting may be performed at another PC, personal digital assistant, or the like which may display a screen of the WEB application.

The image operating section 34 generates data to be used in defect detection in the primary defect detecting section 36 based on the image data input from the image input section 31, and the data input from the parameter input section 32. The generated data is stored in the defect detection data storage section 35. The image operating section 34 is not limited to those provided with a general central processing unit (CPU) as an operating device of the PC, and a main memory connected to the CPU by a bus. Rather, an image processing board implemented on an H/W circuit such as a field programmable gate array (FPGA) may be connected to the main computer 3 via a PCI slot, for example.

The defect detection data storage section 35 stores the image data input from the image input section 31, operation result of the image operating section 34, and various types of information input through the parameter input section 32. The image operating section 34, the primary defect detecting section 36, and the secondary defect detecting section 37 may read the data required for their processing out from the defect detection data storage section 35. The defect detection data storage section 35 is not limited to a common PC storage including a hard disk and removable media. Rather, the defect detection data storage section 35 may be another PC, or a file server such as network attached storage (NAS) network-connected to the main computer 3.

The primary defect detecting section 36 performs a primary defect detection process for detecting a severe defect of more than a predetermined size (e.g., the size of a single chip or multiple chips, or the size of a die) on the wafer. A severe defect occurs due to film nonuniformity of the resist layer applied onto the wafer surface, or failure in exposure. When a severe defect is found on the wafer, the wafer does not proceed to post processes, and needs to be subject to re-application of the resist layer or re-exposure.

For example, when an unexposed wafer is photographed under the same conditions as in photographing a normal wafer, the overall brightness distribution of the photographing image may vary.

The wafer with a severe defect needs to undergo another round of detailed defect detection after previous processing, which is waste of time. In the present embodiment, a wafer is first subject to the primary defect detection before subject to the second defect detection. The primary defect detection is for detecting a severe defect in a short amount of time when compared to the secondary defect detection. Detailed defect detection is performed in the secondary defect detection, which will be omitted when a severe defect is detected in the primary defect detection.

The secondary defect detecting section 37 performs the secondary defect detection process for detecting a wafer defect in detail using the image data of the wafer. The primary defect detecting section 36 and the secondary defect detecting section 37 may be modified within the same range as that of the image operating section 34. The process controller 38 controls execution of the primary defect detection process in the primary defect detecting section 36, and the secondary defect detection process in the secondary defect detecting section 37.

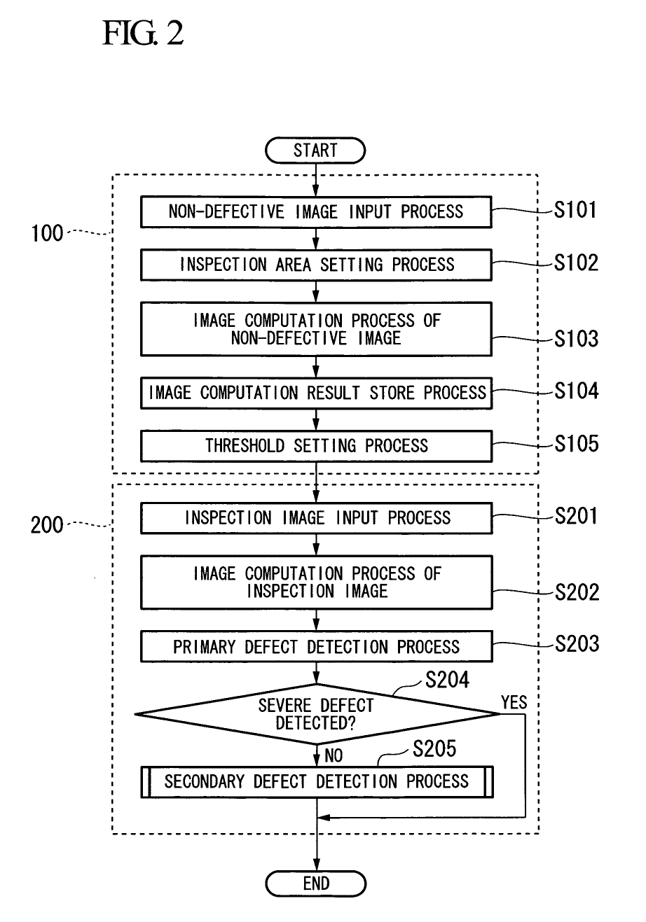

Next, the operation of the substrate inspection system 1 according to the present embodiment will be described with reference to FIG. 2. A non-defective image input process (Step S101) to a threshold setting process (Step S105) constitutes a pre-preparation process 100 which is performed before the defect detection process. An inspection image input process (Step S201) and any subsequent steps constitute a defect detection process 200 which actually performs defect detection to an inspection image. First, the process of the pre-preparation process 100 will be described in sequence.

In the non-defective image input process (Step S101), a non-defective wafer is photographed, and the image data (hereinafter, the image data obtained by photographing the non-defective wafer will be referred to as “non-defective image data”) is input from the image input section 31 and stored in the defect detection data storage section 35.

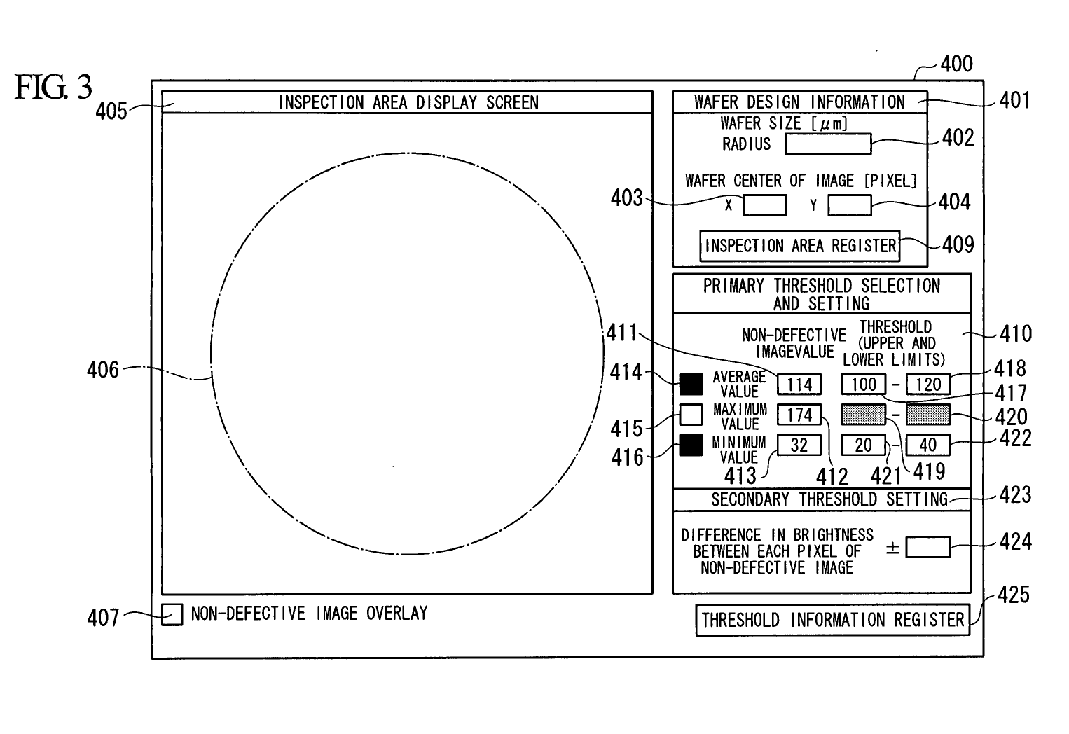

Then, the inspection area is set in an inspection area setting process (Step S102). The inspection area is set in the following manner. A setting screen 400 shown in FIG. 3 is displayed on a screen of the display section 33. The operator inputs information used for setting an inspection area within the image of the wafer into a wafer design information screen 401 using an input device in the parameter input section 32. Information to input is wafer radius representing the wafer size, and X and Y coordinates representing a wafer center in the image. The information is input into text boxes 402 to 404.

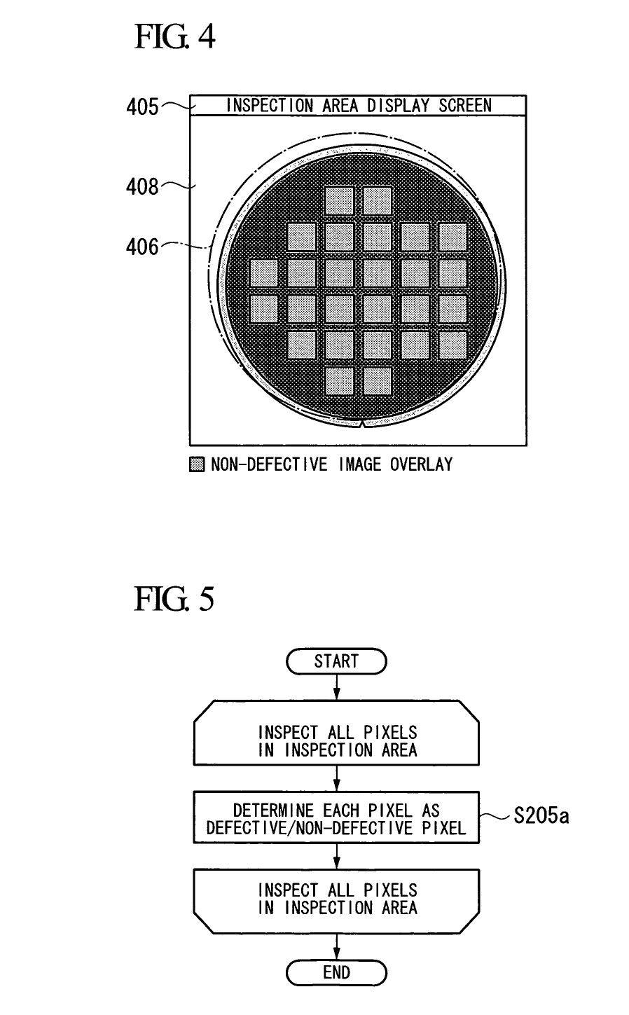

Depending on the input value, the size and position of the inspection area 406 displayed on the inspection area display screen 405 are changed. When the operator checks a non-defective image overlay check box 407 to verify the input value, the non-defective image data is read out from the defect detection data storage section 35, and the non-defective image is displayed on the inspection area display screen 405. In FIG. 4, a non-defective image 408 is overlaid on the inspection area 406. Overlaying allows misalignment between the inspection area and the wafer position in the image to be recognized.

The operator inputs information into the wafer design information 401 to eliminate misalignment between the inspection area 406 and the wafer, and the outer circumference of the inspection area 406 and the wafer to correspond. After the input operation is completed, an inspection area register button 409 is pressed down to store the values of the wafer radius, and the X and Y coordinates of the wafer center are stored in the defect detection data storage section 35.

Subsequently, in an image computation process (Step S103) of a non-defective image, the image operating section 34 reads out the non-defective image data stored in the defect detection data storage section 35, and computes the average, the maximum, and the minimum values of the brightness value of all the pixels in the inspection area. The computed values are displayed in a section of non-defective image values 411 to 413 in a primary threshold selection and setting screen 410 shown in FIG. 3.

Then, in an image computation result store process (Step S104), the image operating section 34 stores the value computed in the image computation process (Step S103) of non-defective image in the defect detection data storage section 35.

Subsequently, in a threshold setting process (Step S105), the operator inputs the threshold from the parameter input section 32 in order to set a threshold used in the primary and secondary defect detection processes. The non-defective image data and the inspection image data are compared in the primary defect detection process of the present embodiment using a central value representing each feature of the non-defective image data and the inspection image data. The parameter available as the central value may include the average value, the maximum value, and the minimum value of brightness. The operator checks check buttons 414 to 416, and selects parameters. For example, the average value and the minimum value of brightness are selected in FIG. 3.

For each parameter to be used in the primary defect detection process, the inspector inputs the upper and lower limits of brightness range as the thresholds in the parameter input section 32. The brightness of a wafer should be within the upper and lower limits to become a non-defective product. Each threshold is input into text boxes 417 to 422. In FIG. 3, since the average value and the minimum value of the brightness are selected as parameters used in the primary defect detection process, the threshold is input into text boxes 417, 418, 421 and 422.

The operator also inputs thresholds used in the secondary defect detection process into a text box 424 of the secondary threshold setting screen 423. Upon completion of input of the thresholds, the threshold information register button 425 is pressed and the input thresholds are stored in the defect detection data storage section 35.

In this manner, the pre-preparation process 100 prior to the defect detection process is completed. However, the procedure of the process performed in the pre-preparation process 100 is not limited to those described above. Any procedures may be adopted so long as the data required for the primary and secondary defect detection processes can be stored in the defect detection data storage section 35. For similar reasons, the display information of the setting screen 400 and the setting method of the data corresponding to the display information may also be changed.

Hereinafter, the procedure of the defect detection process 200 will be described in sequence. In the inspection image input process (Step S201), the wafer to be inspected is photographed under the same condition as in the non-defective product, and the image data input from the image input section 31 (hereinafter, the image data obtained through photographing a wafer to be inspected will be referred to as “inspection image data”) is stored in the defect detection data storage section 35.

Then, in an image computation process (Step S202) of inspection image, the image operating section 34 reads the inspection image data stored in the defect detection data storage section 35, and computes any of the average value, the maximum value and the minimum value of brightness of all the pixels in the inspection area. The computed values are stored in the defect detection data storage section 35. Of the three values, the value to be computed is selected depending on the information set in the primary threshold selection and setting screen 410 shown in FIG. 3. With the information set as in FIG. 3, the image operating section 34 computes the average value and the minimum value of the brightness for all the pixels in the inspection area.

Subsequently, in the primary defect detection process (Step S203), the process controller 38 controls the primary defect detecting section 36 to start the primary defect detection process. In the primary defect detection process, the primary defect detecting section 36 reads the central value (the average value, the maximum value or the minimum value) computed in the image computation process (Step S202) of the inspection image and the threshold set in the threshold setting process (Step S105) out from the defect detection data storage section 35, compares both values, and determines whether or not any severe defect is detected based on the comparison result.

In the example of FIG. 3, the primary defect detecting section 36 determines whether or not the average value of brightness of the inspection image data is in a brightness range represented by the thresholds of the upper and lower limits, and then determines whether or not the minimum value of brightness of the inspection image data is in the brightness range represented by the thresholds of the upper and lower limits. In the present embodiment, if at least one of the central values computed from the inspection image data are outside of the brightness range, the primary defect detecting section 36 determines that a severe defect has been detected, and if both of the central values are outside of the brightness range, the primary defect detecting section 36 determines that a severe defect has not been detected. The determination result is inputted to the process controller 38.

As compared with the image of the non-defective product, in the above-described method, it is determined that a severe defect has been detected if the brightness value of the inspection image is generally low in the inspection area. However, the method of detecting a severe defect is not limited to the same, and any method may be adopted so long as it uniquely detects a severe defect. The detection accuracy improves when it is determined if a severe defect is detected in consideration of total data of the inspection area. Thus, it is preferable that the average value of brightness is principally used, and the maximum and the minimum values are used optionally.

Subsequently, the process controller 38 performs branching determination of the process based on the determination result notified from the primary defect detecting section 36 (Step S204). If a severe defect is detected, the process controller 38 completes the defect detection process. In this case, the secondary defect detecting section 37 omits the secondary defect detection process without starting the secondary detection process.

If no severe defect is detected, the process controller 38 controls the secondary defect detecting section 37 to start the secondary defect detection process (Step S205). In the secondary defect detection process, the secondary defect detecting section 37 detects a defect in the inspection area of the inspection image in detail. Upon completion of the secondary defect detection process, the secondary defect detecting section 37 notifies the process controller 38 that the process is completed. Upon receiving the notice, the process controller 38 completes the defect detection process.

FIG. 5 shows the secondary defect detection process in detail. Referring to FIG. 5, the operation of the secondary defect detecting section 37 will be described below. The secondary defect detecting section 37 reads inspection image data, non-defective image data, and a threshold set in the threshold setting process (Step S105) out from the defect detection data storage section 35, and performs the following processes to the data of all the pixels in the inspection area.

In particular, the secondary defect detecting section 37 computes an upper limit value by adding the threshold for the secondary defect detection input into the text box 424 in the secondary threshold setting screen 423 to the brightness value of each pixel of the non-defective image data, and a lower limit value by subtracting the above-mentioned threshold from the brightness value of each pixel. The secondary defect detecting section 37 sets the acceptable range of the above-mentioned brightness value for each pixel of all the pixels in the inspection area. Then, the secondary defect detecting section 37 determines whether or not the brightness value of each pixel of the inspection image data at the same position as that of the non-defective image data is within the upper and lower limits. When the brightness value of the pixel in the inspection image data is determined to be within the upper and lower limits, the secondary defect detecting section 37 determines if the pixel is a non-defective pixel. When the brightness value of the pixel in the inspection image data is outside the upper and lower limits, the secondary defect detecting section 37 determines if the pixel is a defective pixel (Step S205a).

Although essentially the same as the method above, the secondary defect detecting section 37 may compare an absolute value and a threshold to detect a severe defect if the absolute value is smaller than the threshold. The absolute value is obtained by subtracting the brightness value of each pixel of the inspection image data at the same position as that of the non-defective image data from the brightness value of each pixel in the non-defective image data.

If it is certain that the primary defect detection process is completed in a shorter amount of time as compared to the secondary defect detection process, other indices with which the overall brightness tendency of the pixels in the inspection area can be recognized may be used as parameters for the primary defect detection process in addition to the average value, the maximum and the minimum of brightness. For example, the variance and the median of brightness may be used.

Any threshold may be used in the primary defect detection process so long as it can be used for exclusive determination. For example, the lower limit of the threshold may be set as the value of 90%, and the upper limit of the threshold may be set as the value of 120%, of the brightness value of non-defective image.

Although the same area is inspected in the primary and secondary defect detection processes in the described embodiment, if a fatal defect occurs in a restricted area (especially, the area is smaller than the inspection area of the secondary defect detection process), the defect detection processes may be performed independently in the primary and secondary defect detection processes so long as the following relationship is satisfied: the inspection area of the primary defect detection process is less than (<) the inspection area of the secondary defect detection process.

As described above, when a severe defect which affects post processes is detected in the primary defect detection process according to the present embodiment, the secondary defect detection process is omitted. Thus, unnecessary continuation of the secondary defect detection process is eliminated to reduce the inspection time.

### Second Embodiment

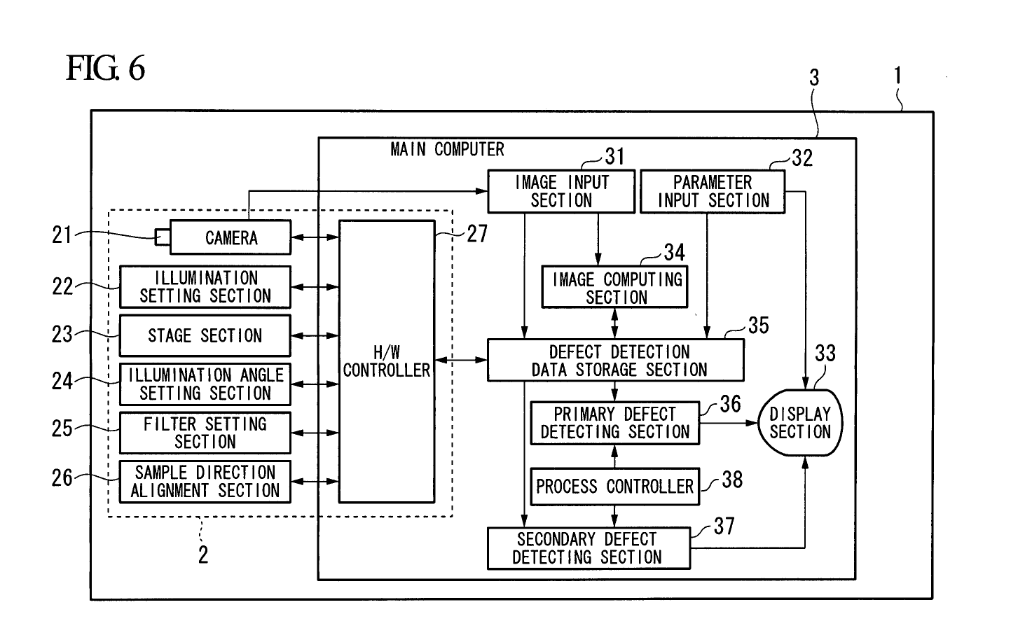

Next, a second embodiment of the invention will be described. FIG. 6 shows a structure of a substrate inspection system according to the second embodiment. In FIG. 6, similar components to those in FIG. 1 are denoted by similar reference numerals. In the present embodiment, an H/W controller 27 is connected to a defect detection data storage section 35 such that control data which is used in the H/W controller 27 to control each component can be stored in the defect detection data storage section 35.

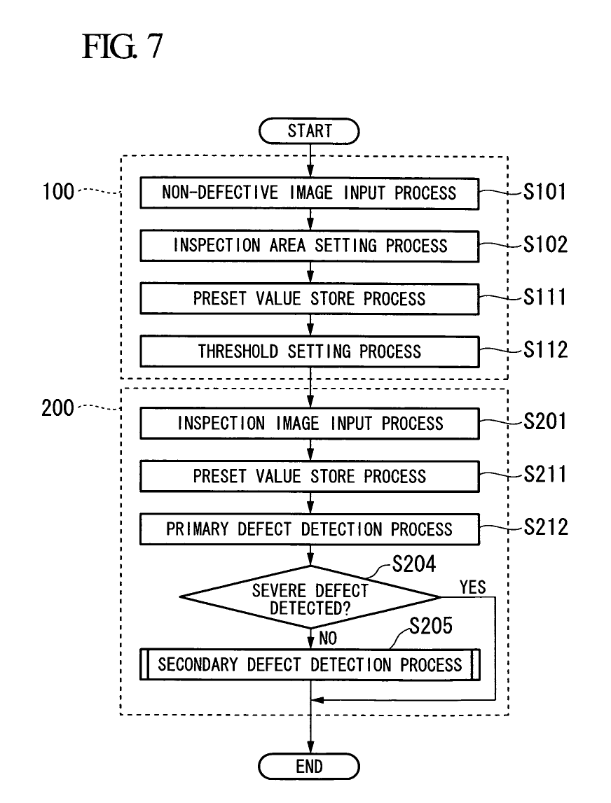

Referring now to FIG. 7, the operation of a substrate inspection system 1 according to the present embodiment will be described. In FIG. 7, similar components to those in FIG. 2 are denoted by similar reference numerals. However, even if the name of the component is the same, different reference numerals may sometimes be used in order to emphasize that a modification has been made to the process. Description of the processes similar to those shown FIG. 2 will be omitted.

In a pre-preparation process 100, index values of brightness of an image of the non-defective image data (i.e., an integral value or an average value of brightness of the image data and the like) are first computed in an image operating section 34 in a non-defective image input process (Step S101). The computed index value is stored in the defect detection data storage section 35, and is output to an H/W controller 27. In a preset value memory process (Step S111), a preset value (control value) of the photographing condition for photographing the wafer of a non-defective product is output from the H/W controller 27, and is stored in the defect detection data storage section 35. In particular, the preset value of the photographing condition relates to the amount of light incident on the camera 21 or to brightness of the image. Examples of the preset value may include the gain set value, the offset preset value, the shutter speed, the preset value of exposure time, the light transmission quantity (transmissivity) of an ND filter (dimming filter) provided in an imaging optical system of the camera 21, and the voltage/current value in case of electric control lighting.

In a threshold setting process (Step S112), the upper and lower limits of the preset value of the photographing condition are input as the thresholds in the parameter input section 32. The preset value of a wafer should be within the upper and lower limits to become a non-defective product in the primary defect detection process. Here, as in the first embodiment, the value at the time of photographing the non-defective image may be displayed as a reference value, and the above-described threshold may be set based on the reference value. The set threshold is stored in the defect detection data storage section 35. The threshold used in the secondary defect detection process is also input, and is also stored in the defect detection data storage section 35.

In the defect detection process 200, photographing is performed with the initial value of the preset value of the photographing condition set in advance in an inspection image input process (Step S201). The index values of brightness of an image of the non-defective image data (i.e., an integral value or an average value of brightness of the image data and the like) are computed in an image operating section 34. The computed index value is stored in the defect detection data storage section 35, and is output to the H/W controller 27.

The H/W controller 27 repeats changing the preset values of the photographing condition until the index value for photographing the non-defective image and the index value for photographing an inspection image become almost equal. The preset value of the photographing condition when both index values become almost the same is stored in the defect detection data storage section 35 in a preset value memory process (Step S211).

In a primary defect detection process (Step S212), the primary defect detecting section 36 reads the preset value of the photographing condition for photographing the non-defective image stored in the defect detection data storage section 35 in a preset value memory process (Step S111), the preset value of the photographing condition stored in the defect detection data storage section 35 in the preset value memory process (Step S211) under which the index value for photographing the non-defective image and index value of inspection image are almost equal, and the threshold set in a threshold setting process (Step S112) out from the defect detection data storage section 35. Then the primary defect detecting section 36 compares these values to determine whether or not any severe defect exists.

In particular, the primary defect detecting section 36 determines whether or not the preset value for photographing the inspection image is within the limits represented by the difference between, and the sum of, the preset value and the threshold for photographing the non-defective image. When the preset value for photographing the inspection image is not within the range defined by the preset value and the threshold for photographing the non-defective image, it is determined that a severe defect has been detected. When it is within the range defined by the preset value and the threshold for photographing the non-defective image, it is determined that no severe defect has been detected.

Any method may be adopted for detecting defects in the secondary defect detection process (Step S205) so long as detection is performed using image data (for example, the method disclosed in Japanese Unexamined Patent Application, First Publication No. 10-3546 may be used).

As described above, according to the present embodiment, the inspection time can be reduced as in the first embodiment. In particular, since each line can be photographed while rapidly changing the gain in preset value and the shutter speed of the camera of the substrate inspection system, and the primary defect detection can be performed for each line, the inspection time may be further reduced.

### Third Embodiment

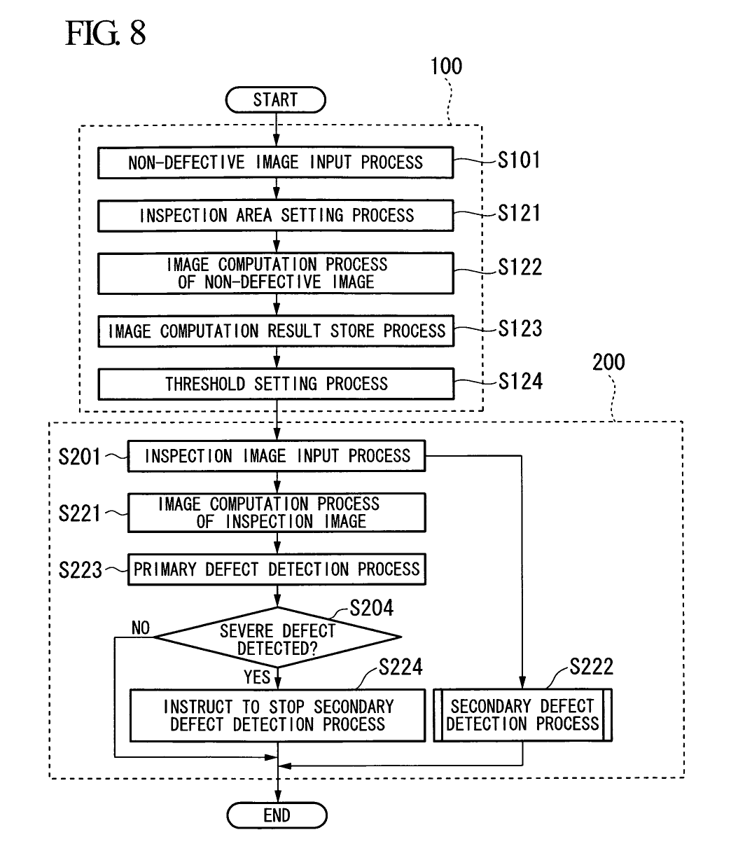

Next, a third embodiment of the invention will be described. Since the structure of the substrate inspection system according to the present embodiment is the same as that shown in FIG. 1, an illustration thereof is omitted. Hereinafter, the operation of the substrate inspection system 1 according to the present embodiment will be described with reference to FIG. 8. In FIG. 8, same processes to those in FIG. 2 are denoted by same reference numerals. However, even if the component name is the same, different reference numerals may sometimes be used in order to emphasize that a modification has been made to the process. Description of the processes similar to those shown FIG. 2 will be omitted.

First, the process of a pre-preparation process 100 will be described. Following a non-defective image input process (Step S101), an inspection area is set in an inspection area setting process (Step S121). In the present embodiment, the inspection area is set for inspecting multiple dies which are the minimum unit or product cut from a wafer, which is a repeating pattern. Setting of the inspection area is performed in the following manner.

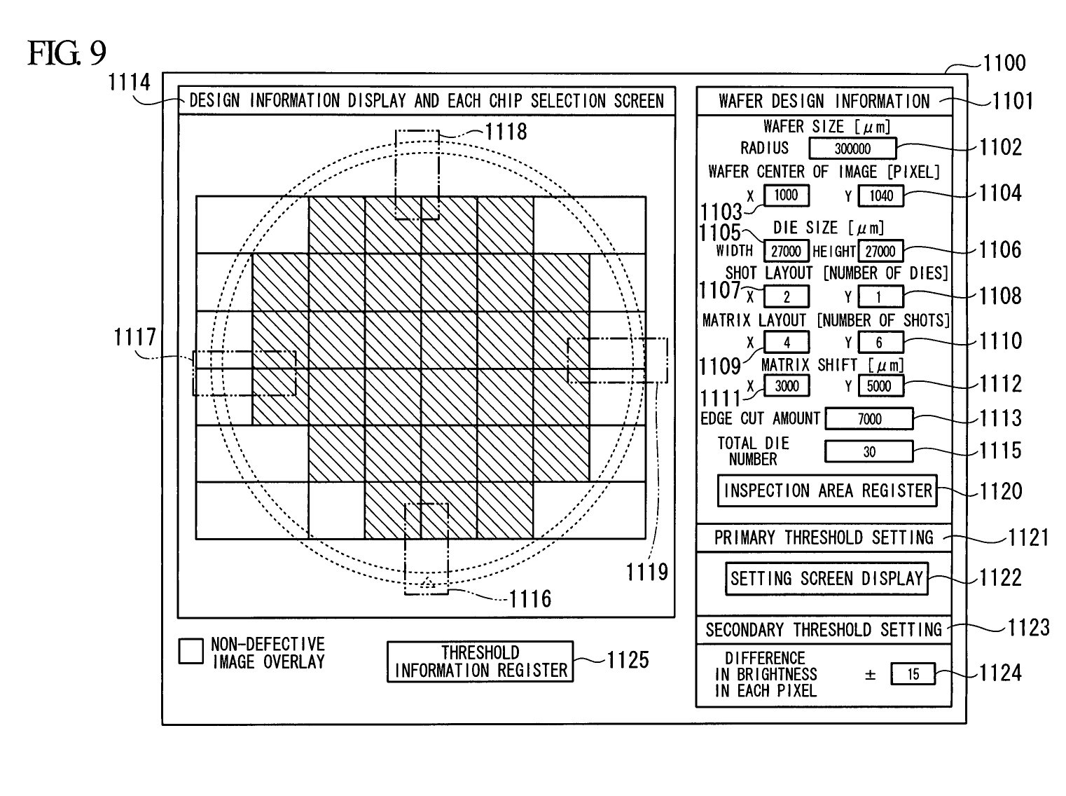

A setting screen 1100 shown in FIG. 9 is displayed on a screen of the display section 33. The operator inputs information used for setting an inspection area within the image of the wafer into wafer design information screen 1101 using an input device in the parameter input section 32. Information to input is wafer radius, and X and Y coordinates of the wafer center image. The information is input into text boxes 1102 to 1104.

Value representing the width and height which represent the size of a die is input into text boxes 1105 to 1106, respectively. The number of dies in the X direction and the number of the dies in the Y direction which determine a shot layout (the number of dies in the shot) are input into text boxes 1107 and 1108, respectively. An X direction shot number and a Y direction shot number which determine a matrix layout (shot number in a wafer) are input into text boxes 1109 and 1110, respectively.

An X direction shift amount and a Y direction shift amount representing a matrix shift amount (i.e., the amount of misalignment of a shot layout with respect to a wafer center) are input into text box 1111 and 1112, respectively. The amount of edge cut is input into a text box 1113. Values based on the design information of the wafer are input into the text boxes 1102 to 1113 by the operator.

When the above-mentioned values are input, a wafer map corresponding to the input value is displayed on a design information display and each chip selection screen 1114. When the operator selects a desired die in the inspection area displayed on the design information display and each chip selection screen 1114, the die will be removed from the inspection area. When the operator selects the die again, the die will be re-registered into the inspection area. Thus, the total number of the dies in the set inspection area is displayed on a total die number display box 1115.

Matching areas 1116 to 1119 which correct in the matching image process the misalignment generated between the non-defective image and the inspection image due to transfer error of the sample or the like are also displayed on the wafer map of the design information display and each chip selection screen 1114. Since in some inspection images, matching cannot be obtained at a position in a single matching area, multiple matching areas can be set.

While four matching areas may be set in the present embodiment, any number more than two of the matching areas may be set. If unnecessary, no matching area needs to be set. The setting position of the matching area may be changed. The size of the matching area may or may not be constant. However, it is to be noted that larger matching areas needs longer matching times.

Upon completion of the above-mentioned input operation, the inspection area register button 1120 is pressed and the input value is stored in the defect detection data storage section 35.

Subsequently, in an image computation process (Step S122) of a non-defective image, the image operating section 34 reads the non-defective image data out from the defect detection data storage section 35, and generates a histogram of brightness from the data on all the pixels in the inspection area set in the inspection area setting process (Step S1121). Before the generation process of the histogram, the histogram is set in the following manner.

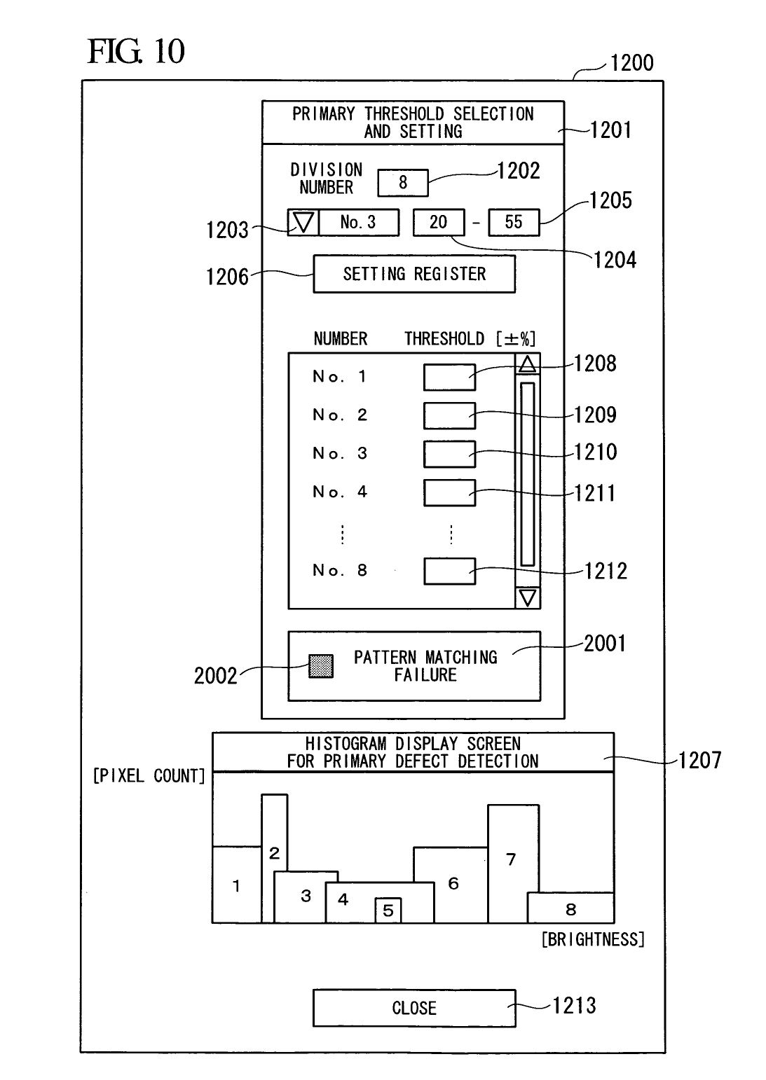

When the operator presses a setting screen indication button 1122 in a primary threshold setting screen 1121 in a setting screen 1100 shown in FIG. 9, a setting screen 1200 shown in FIG. 10 is displayed. Setting of the histogram is performed in the following manner. First, the operator inputs numerical values into a text box 1202 in a primary threshold selection and setting screen 1201, and the input numerical values are set as the number of classes (division number) of the histogram.

Then, in order to set the brightness range for each class, the operator presses a selection button 1203 of the class number, selects the number of class to set, and inputs the lower and upper limits of the brightness range of the class into text boxes 1204 to 1205, respectively. While the number of classes of the histogram is 8 in the example shown in FIG. 10, any number of classes may be included in the histogram as long as the number is a natural number which does not exceed the range of brightness.

Upon completion of the setting of the brightness range to all of the classes, the operator presses a setting registration button 1206, and establishes the classes. After the classes are established, the image operating section 34 generates a histogram of a non-defective image based on the above-mentioned setting detail. The generated histogram is displayed on a histogram display screen 1207 for the primary defect detection. In the present embodiment, in order to allow the operator to confirm the setting of histogram, the histogram of the non-defective image is displayed. However, the histogram of the non-defective image is not necessarily displayed.

Then, information concerning the setting of the histogram is stored in the defect detection data storage section 35 in an image computation result store process (Step S123).

Subsequently, in a threshold setting process (Step S124), thresholds used in the primary and secondary defect detection processes are set. First, the operator inputs a threshold for each class used in the primary defect detection process into text boxes 1208 to 1212 in a primary threshold selection and setting screen 1201 shown in FIG. 10. In FIG. 10, values of percentage the upper and lower limits to the pixel count of the non-defective image are set as thresholds. The thresholds are not limited to these, and may be any value including the upper limit and the lower limit of the pixel count so long as it can be used for exclusive determination for each class.

Upon completion of setting the thresholds for the primary defect detection in the above procedure, a close button 1213 is pressed to close the setting screen 1200. Then, the threshold for the secondary defect detection is set in the setting screen 1100 shown in FIG. 9. The operator inputs the threshold for the secondary defect detection into a text box 1124 in the secondary threshold setting screen 1123. The thresholds for the secondary defect detection are also not limited, and may be any value as long as it can be used exclusively for the determination of each class. When the operator presses a threshold information register button 1125, the thresholds input as described above are stored in the defect detection data storage section 35.

With the above processes, the pre-preparation process 100 before defect detection process is completed. However, the procedure of the process performed in the pre-preparation process 100 is not limited to the procedure described above, and any procedure may be adopted as long as it can store the data required in the primary and secondary defect detection processes in the defect detection data storage section 35. For the same reason, the display information of the setting screen 1100 to 1200 and the setting method of the data corresponding to the information may also be changed. In the defect detection process 200 of the present embodiment, since the non-defective image data is unnecessary, the non-defective image data stored in the defect detection data storage section 35 may be deleted as long as it is not necessary to perform the pre-preparation process 100 again.

Hereinafter, the defect detection process 200 will be described. In the present embodiment, in order to reduce the inspection time more than in the first embodiment, an image computation process (Step S221) of the inspection image and a secondary defect detection process (Step S222) are performed in parallel following an inspection image input process (Step S201).

In the image computation process (Step S221) of the inspection image, the image operating section 34 reads data concerning the setting of the histogram and the inspection image data out from the defect detection data storage section 35, and generates a histogram based on the brightness value of all the pixels in the inspection area. The data of the generated histogram is stored in the defect detection data storage section 35.

Subsequently, in a primary defect detection process (Step S223), the primary defect detecting section 36 reads the data and the threshold for the histogram out from the defect detection data storage section 35, and a severe defect is detected by whether the frequency of each class of the histogram is within the limits defined by the threshold. In the present embodiment, if there is at least one class of which the frequency becomes outside of the frequency range in the class of the histogram, it is determined that a severe defect has been detected. If the frequencies of all the classes are within the limits, it is determined that no severe defect has been detected. The determination result is notified to the process controller 38.

For example, when the brightness value of the inspection image is high on the whole at a chip section of the inspection area as compared with the image of the non-defective product, according to the above-described method, it is determined that a severe defect has been detected. The method of detecting a severe defect is not limited to that described above, and any method can be adopted as long as it can uniquely detect a severe defect.

Then, the process controller 38 performs a branching determine of a process based on the determination result notified from the primary defect detecting section 36 (Step S204). When a severe defect is detected, the process controller 38 instructs the secondary defect detecting section 37 to stop the secondary defect detection process. The secondary defect detecting section 37 receives the instruction and stops the secondary defect detection process (Step S224). Then, the process controller 38 completes the defect detection process.

When no severe defect is detected, the process controller 38 waits for a notice that the secondary defect detection process is completed from the secondary defect detecting section 37. The secondary defect detecting section 37 has started the secondary defect detection process following the inspection image input process (Step S201). Upon completion of the secondary defect detection process, the secondary defect detecting section 37 notifies process controller 38 that process is completed. Upon receiving the notice, the process controller 38 completes the defect detection process.

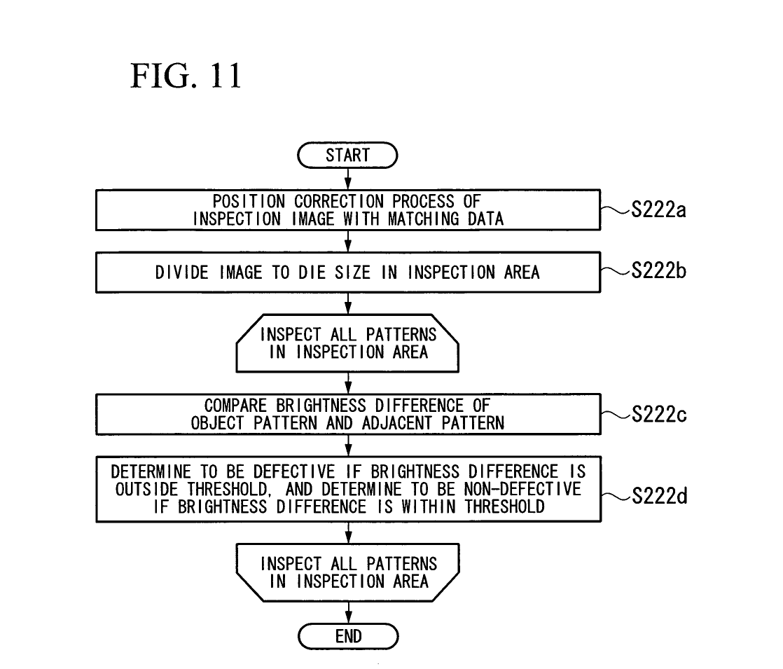

FIG. 11 shows the secondary defect detection process in detail. Hereinafter, according to FIG. 11, the operation of the secondary defect detecting section 37 will be described. The secondary defect detecting section 37 reads the inspection image data and the non-defective image data out from the defect detection data storage section 35, and performs a position misalignment correction of the inspection image using data of matching the area set at Step S121 (Step S222a) (hereinafter, referred to as “matching data”).

The matching is performed using a method of retrieving similar patterns which is common in image processing. In particular, a matching process is performed to the inspection image using positional information of the matching area in the non-defective image and a location in the inspection image with high similarity with the matching data near the same position in the non-defective image.

The thus-obtained misalignment between the non-defective image and the inspection image corresponds to a correction amount. In the present embodiment, the above-mentioned retrieval is performed using four types of matching data, and the average value of the misalignment amount in the position with high similarity is made as a correction amount. Alternatively, an average value of the entire misalignment amount obtained through retrieval may be made a correction amount.

Following the misalignment correction, the secondary defect detecting section 37 reads data set at Step S121 out from defect detection data storage section 35, and divides the image in the inspection area into small images of die size (Step S222b) (hereinafter, the images will be referred to as “die size image”). Then, the secondary defect detecting section 37 repeats the processes of Steps S222c to S222d for all of the die size images.

In Step S222c, the secondary defect detecting section 37 compares the brightness of all the pixels with adjacent die size images. In the step S222d, the secondary defect detecting section 37 determines the object pixel to be a non-defective pixel if the brightness difference is within the limits of threshold, and determines the object pixel to be a defective pixel if the brightness difference is outside the range of the threshold.

The secondary defect detection process of the present embodiment may be substituted by other defect detection processes which do not use non-defective image (for example, refer to Japanese Patent Application Laid-Open Nos. 9-64130 and 9-203621 mentioned above). Alternatively, a severe defect may be detected in the following manner. The information on light angle is made to be stored in the defect detection data storage section 35. The non-defective image and the inspection image are photographed from varying angles. The primary defect detection process compares the average brightness value for each light angle between the non-defective image and the inspection image using a graph data (instead of a brightness histogram) plotting the light angles along the abscissa axis and the average brightness values of the inspection image photographed at the light angles along the ordinate axis.

As described above, according to the present embodiment, since the secondary defect detection process is stopped when a severe defect is detected in the primary defect detection process after starting the primary and secondary defect detection processes as mentioned above, inspection time can be reduced. Also, since the secondary defect detection process is started at the same time with the primary defect detection process, the inspection time can be reduced when no severe defect is detected.

While no severe defect may be detectable in the defect detection method which compares patterns in the inspection image, as in the present embodiment, severe defect can certainly be detected by performing both the primary defect detection process for severe defect detection, and the secondary defect detection process by pattern comparison in the inspection image.

In the present embodiment, as shown in FIG. 10, a check box button 2002 is provided in a pattern matching failure frame 2001 located below the primary threshold selection and setting screen 1201 of the setting screen 1200. The operator may check the check box when he/she wants that an unsuccessful matching (i.e., no matching is made) may also be included as a factor of a severe defect. The original purpose of matching is to correct the carrying error of the wafer as described above, but the pattern matching may also be used for detecting a defect. For example, if a bare wafer is inadvertently set as an inspection object with respect to the non-defective image, an image with no pattern on the wafer is photographed. Further, if a wafer with significantly a different chip design is inadvertently set as an inspection object, significantly different images are photographed. In such situations, it is not at all required to determine whether or not a defect exists on the wafer, and the secondary defect detection process may preferably be omitted or, if already started processing, be stopped supposing that a severe defect has been detected. In this case, the ON/OFF state of the check box button 2002 of the pattern matching failure frame 2001 is newly stored in the defect detection data storage section 35.

For defect detection, a severe defect may be detected when the state of the check box button 2002 is read out at the beginning of the primary defect detection and only when the state is ON, the matching process to be performed at the beginning of the secondary defect detection shown in FIG. 11 is performed. A matching failure may be considered as occurrence of a severe defect. In this manner, selection failure of the inspection object may also be detected as well as a severe defect as described above.

### Fourth Embodiment

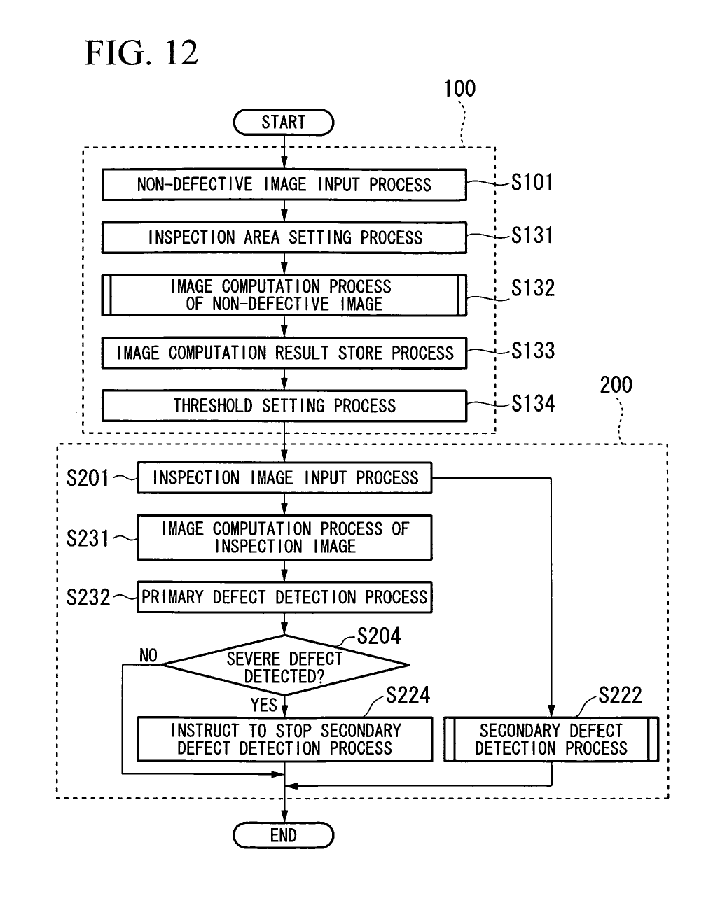

Next, a fourth embodiment of the invention will be described. Since the structure of the substrate inspection system according to the present embodiment is the same as that shown in FIG. 1, illustration thereof will be omitted. Hereinafter, the operation of the substrate inspection system 1 according to the present embodiment will be described with reference to FIG. 12. In FIG. 12, similar components to those in FIG. 2 and FIG. 8 are denoted by same reference numerals. However, even if the component name is the same, different reference numerals may sometimes be used in order to emphasize that modification has been made to the process. Description on the processes same to those shown FIG. 2 and FIG. 8 will be omitted.

First, the pre-preparation process 100 will be described. Following the non-defective image input process (Step S101), an inspection area is set in an inspection area setting process (Step S131). In the present embodiment, multiple areas are set in the inspection area, and existence a severe defect is detected in each area. Setting of the inspection area is performed in the following manner.

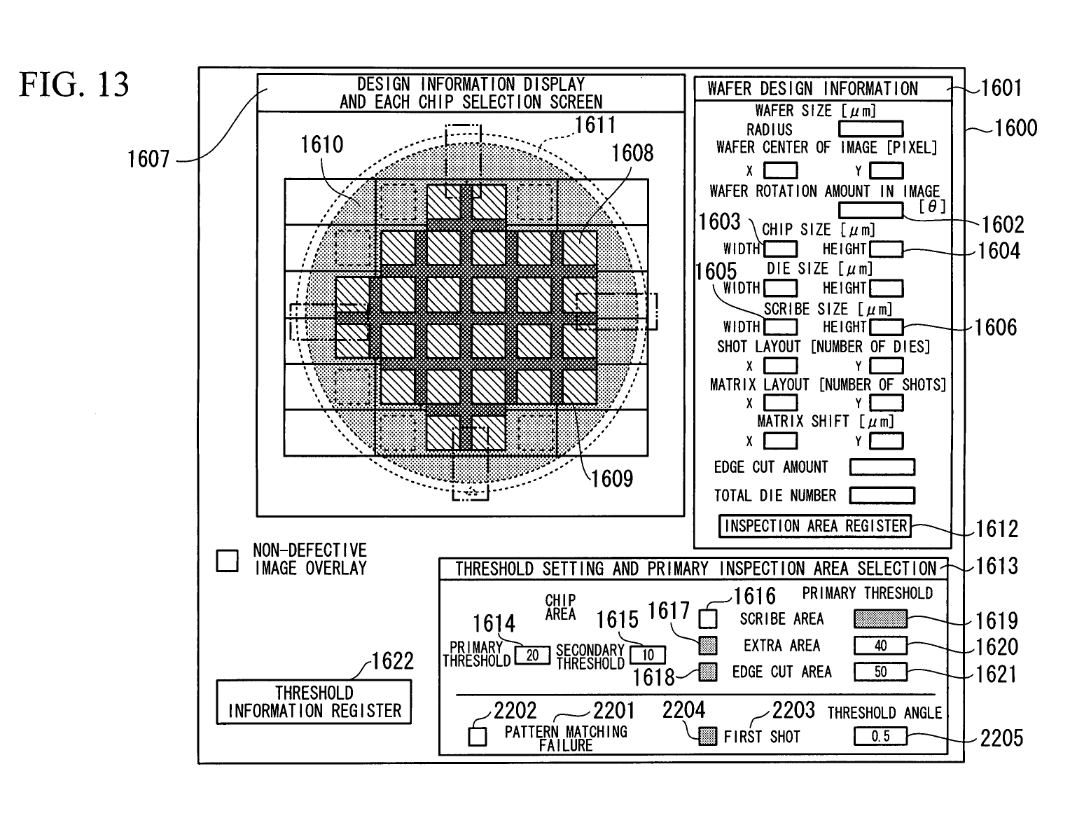

A setting screen 1600 shown in FIG. 13 is displayed on a screen of the display section 33. The operator inputs information used for setting an inspection area within the image of the wafer into wafer design information screen 1601 using an input device in the parameter input section 32. In the wafer design information screen 1601, descriptions of components similar to those in the wafer design information screen 1101 shown in FIG. 9 will be omitted.

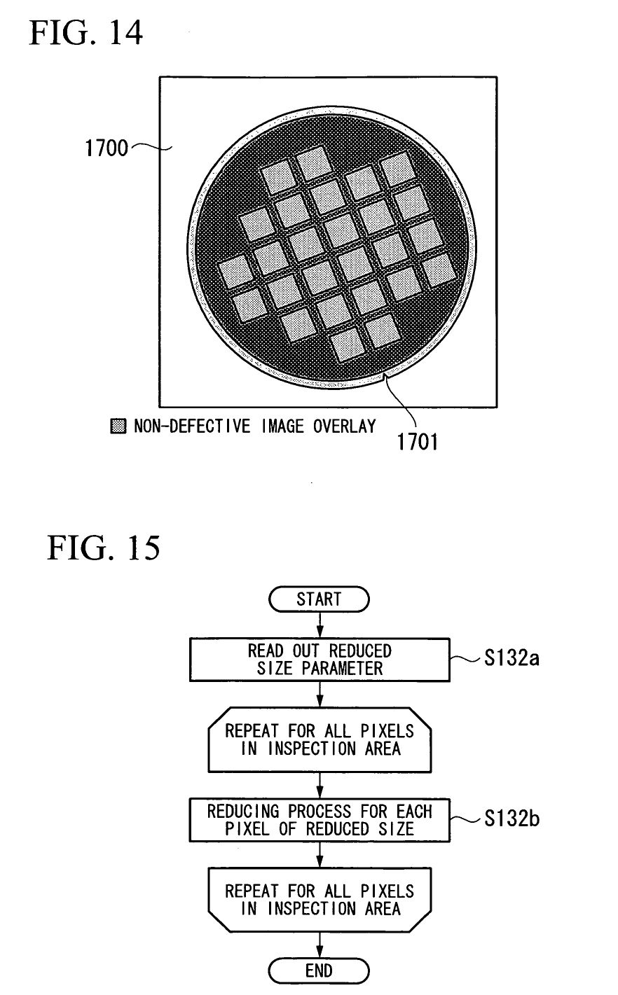

As shown in an image 1700 of FIG. 14, defect detection may sometimes be more effectively performed when photographed with a notch 1701 at an angled position rather than at a downward position. For example, when an outgoing direction of the diffracted light varies depending on the pattern on the wafer, the wafer is preferably photographed from the direction corresponding to the outgoing direction. Thus, the wafer may be rotated to any angle. The rotated angle of the wafer is input into a text box 1602 of FIG. 13 with an angle in which the notch faces downward as 0 degrees.

Values of the width and height representing the size of a chip included in a die are input into text boxes 1603 and 1604. Generally, since the most important inspection area in a substrate inspection is a chip, the chip area may be set independent of the die area in the present embodiment. The chip size and the die size should fulfill the following relationship:

the chip size width (height) is less than or equal to (≦) the die size width (height).

Values of the width and height representing the size (scribe size) of a scribe area (an area to be cut when dicing the chips in the post process) included in the die are input into text boxes 1605 and 1606. You may want to exclude the scribe area from the subject area in substrate inspection, since fatal defects such as severe defects may often be detected in the scribe area, the scribe area may be included in the inspection area in the present embodiment. The scribe size and the die size should fulfill the following relationship:

the scribe size width (height) added to (+) the chip size width (height) is less than or equal to (≦) the die size width (height).

With the parameters of the chip size and the scribe size, supposing that a lower left portion of a die is defined as an original position with the wafer notch facing downward, a position of the chip displaced from the original position to the right by the distance corresponding to the width of the scribe size, and upward by a distance corresponding to the height of the scribe size is defined as a lower left position of the chip. As shown in the wafer map displayed on a design information and each chip selection screen 1607 of FIG. 13, the wafer is divided into four areas: a chip area 1608, a scribe area 1609, an extra area 1610, and an edge cut area 1611 in accordance with the above-mentioned definition.

At the present embodiment, the inspection area is set not in a die unit but in a chip unit. A chip area 1608 in the design information and each chip selection screen 1607 is set as the inspection area for primary and secondary defect detection processes. The operator may select the other three areas (the scribe area 1609, the extra area 1610, and the edge cut area 1611) as inspection areas for the primary defect detection process.

When an inspection area register button 1612 is pressed, the thus-set data in the inspection area is stored in the defect detection data storage section 35. The data may be used to reconstruct the wafer map displayed on the design information and each chip selection screen 1607 of FIG. 13. The positions of the chip area, scribe area, extra area, and edge cut area in the wafer can be identified from the data.

Then, in a non-defective image computation process (Step S132), the image operating section 34 reads non-defective image data out from the defect detection data storage section 35, and performs the following image conversion process (resolution conversion process). Hereinafter, the image conversion process will be described with reference to FIG. 15.

In the image conversion process, the pixel count is reduced, for example, by converting 4×4 pixel data into 1-pixel data. A reduced size parameter representing a number of pixels which are converted into 1-pixel data is stored in advance in the defect detection data storage section 35. The image operating section 34 reads the reduced size parameter out from the defect detection data storage section 35 (Step S132a), and generates 1-pixel data for each pixel of a predetermined number indicated by the reduced size parameter for all the pixels in the wafer (Step S132b).

In this process, the average value of brightness for all the 4×4 pixels may be set as a brightness value of 1 pixel after image conversion, or the brightness value of a leading pixel of the 4×4 pixels may be set as a brightness value of 1 pixel after image conversion. The reduced size parameter may be constant or may be changed by the operator.

When the non-defective image data with reduced pixel count (hereinafter referred to as “reduced non-defective image data”) is generated in the image non-defective image computation process (Step S132), the reduced non-defective image data is stored in the defect detection data storage section 35 in an image computation result store process (Step S133).

Then, in a threshold setting process (Step S134), thresholds used in the primary and secondary defect detection processes are set. The inspection area is also selected along with the threshold setting. Selection of the inspection area and setting of the threshold for each inspection area are performed in a threshold setting and primary inspection area selection screen 1613 of FIG. 13.

As to the chip area, thresholds for the primary and secondary defect detection processes are input into text boxes 1614 and 1615. As to other three areas, areas to be set as inspection areas of the primary defect detection process are selected by the operator selecting check boxes 1616 to 1618. The extra area and the edge cut area are selected as inspection areas in FIG. 13. Thresholds for the primary defect detection process of each area are input into text boxes 1619 to 1621. When a threshold information register button 1622 is pressed, the above-set selection information and the thresholds of the inspection area are stored in the defect detection data storage section 35.

In this manner, the pre-preparation process 100 prior to the defect detection process is completed. However, the procedure of the process performed in the pre-preparation process 100 is not limited to those described above. Any procedure may be adopted as long as the data required for the primary and secondary defect detection processes can be stored in the defect detection data storage section 35. For similar reasons, the display information of the setting screen 1600 and the setting method of the data corresponding to the display information may also be changed.

Hereinafter, the procedure of the defect detection process 200 will be described. As in the third embodiment, subsequent to the inspection image input process (Step S201), the image computation process (Step S231) of the inspection image and the secondary defect detection process (Step S222) are performed in parallel.

In the image computation process (Step S231) of the inspection image, the image operating section 34 reads the inspection image data out from the defect detection data storage section 35, and performs the image conversion process described above to the inspection image data. The inspection image data with reduced pixel count (hereinafter, referred to as “reduced inspection image data”) is stored in the defect detection data storage section 35.

Then, in the primary defect detection process (Step S232), the primary defect detecting section 36 reads the reduced non-defective image data, reduced inspection image data, data of inspection area set in the inspection area setting process (Step S131), and the data of threshold and the like which are set in the threshold setting process (Step S134) out from the defect detection data storage section 35, and determines whether or not a severe defect exists using the data. In particular, the primary defect detecting section 36 identifies the position of the inspection area based on the data of the inspection area, and compares the brightness value of the reduced non-defective image data and the reduced inspection image data for each pixel of all the pixels in the inspection area in the same manner as in the procedure shown in FIG. 5.

The primary defect detecting section 36 determines the object pixel as a non-defective pixel if the brightness difference is within the limits of threshold, and determines the object pixel as a defective pixel if the brightness difference is outside the threshold range. The primary defect detecting section 36 also determines the existence of a severe defect for each inspection area by determining whether or not the number of defective pixels is more than a predetermined number in each inspection area (or whether or not the percentage of the defective pixel in all the pixels in the inspection area is larger than a predetermined value).

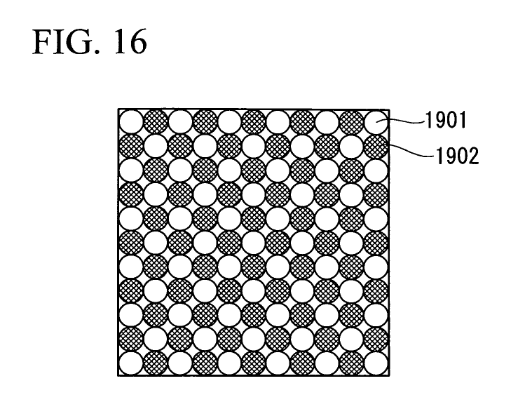

The Image conversion process of the present embodiment may be performed in the H/W circuits such as FPGA, and may be processed at high speed. The method of reducing the pixel count of the image for the primary defect detection process than the pixel count of the image for the secondary defect detection process is not limited to the above-described method. Supposing that white circles 1901 and shaded circles 1902 of FIG. 16 represent detecting elements of each pixel of a camera, an image may be constituted by the information output from the detecting elements represented by the shaded circles in the primary defect detection process, and an image may be constituted by the information output from the detecting elements represented by the white circles and shaded circles in the secondary defect detection process.

As described above, in accordance with the present embodiment, since the primary defect detection process is performed using the reduced non-defective image data and the reduced inspection image data with reduced pixel count, the process time of the primary defect detection process can be reduced. The following advantageous effects are also obtained in the present embodiment.

According to the first to third embodiments, a severe defect may be detected in the primary defect detection process, but the position of the severe defect cannot be detected. In the present embodiment, since reduction in the pixel count enables reduction in the process time of the primary defect detection process, the process time may be reduced even if a determination is made of each pixel as to whether or not they are defective. In this way, even the position of the defect can be detected from the determination result for each pixel in the present embodiment.

In the present embodiment, a severe defect on the wafer may be detected for each inspection area based on the comparison result of each pixel, and the position of each inspection area (the chip area, the scribe area, the extra area, and the edge cut area). The detection result of a severe defect for each inspection area is useful for estimating the occurrence of abnormalities in a manufacture device of previous processes. Since the position of the inspection area is recognized, each pixel and each inspection area may be uniquely correlated with each other, and thresholds may be set for each inspection area. Thus, detection sensitivity of a severe defect may be controlled for each inspection area.

A pattern matching failure frame 2201 and a check box button 2202 may be provided in a threshold setting and primary threshold selection screen 1613 of FIG. 13, with which matching processing may be performed at the beginning of the primary defect detection, and any wrong selection to be inspected may be detected.

For a first exposure (i.e., a first shot) to the bare wafer, the exposing position is determined with respect to the notch orientation and the position of the wafer center and thus alignment error becomes large. For example, the pattern may significantly tilt with respect to the notch orientation as shown in FIG. 14. In the second exposure and thereafter, an alignment mark for relative positioning to the last exposure is prepared, and making the size of alignment mark to minute size, precise alignment may be made without causing above-described problems. A first shot frame 2203, a check box button 2204, and a threshold angle text box 2205 are provided in the right-hand of the check box button 2202 of the pattern matching failure frame 2201 in the threshold setting and primary threshold selection screen 1613 of FIG. 13. A matching process is performed at the beginning of the primary defect detection process with the preset value kept. If a rotation correct amount computed in the matching process at that time is beyond the threshold, it may be defected as a severe defect. Thus, occurrence of first shot misalignment can be detected

While preferred embodiments of the invention have been described with reference to drawings, the detailed structure is not limited to those described. Design change without departing the spirit of the invention may be made. For example, in the substrate inspection, various non-defective images are to be prepared depending on the substrate types or processes, it suffices that the pre-preparation process 100 shown in FIG. 2 is performed before the defect detection process 200 on the inspection image related to the non-defective image. The non-defective image may be repeatedly processed at the pre-preparation process 100. In particular, the pre-preparation process 100 may be performed collectively for two or more non-defective images, and when an inspection image is obtained, the defect detection process 200 may be performed. Although different processes are disclosed for each embodiment about the secondary defect detection process, a combination of the primary defect detection process and the secondary defect detection process is not limited to those shown in the embodiments, and may be selected including another known defect detection process.

While preferred embodiments of the invention have been described and illustrated, the description is not to be construed as limiting the invention. Other embodiments of the invention will be apparent to those skilled in the art when considering the specification. Various modifications of the disclosed embodiments may be made without departing from the scope of the invention defined in the claims.

What is claimed is:

1. A defect detection apparatus comprising:
a primary defect detecting device which performs a primary defect detection process for detecting a severe defect of more than a predetermined size on an inspection object;
a secondary defect detecting device which performs a secondary defect detection process for detecting a defect on the inspection object using image data of the inspection object; and
a process control device for controlling performance of the primary defect detection process and the secondary defect detection process,
wherein the process control device omits the secondary defect detection process upon detection of the severe defect in the primary defect detection process before starting the secondary defect detection process, or stops the secondary defect detection process upon detection of the severe defect in the primary defect detection process after starting the secondary defect detection process.

2. The defect detection apparatus according to claim 1, wherein the primary defect detecting device detects a severe defect on the inspection object by comparing image data of a non-defective product with image data of the inspection object.

3. The defect detection apparatus according to claim 2, wherein the primary defect detecting device detects a severe defect by comparing a central value of image data of the inspection object computed in an image computation process with a threshold set in a threshold setting process.

4. The defect detection apparatus according to claim 1, further comprising a photographing condition controlling device for controlling a photographing condition for a non-defective product and the inspection object based on a control value,
wherein the primary defect detecting device detects a severe defect on the inspection object by comparing the control value relating to photographing of the non-defective product with the control value relating to photographing of the inspection object.

5. The defect detection apparatus according to claim 1, wherein the primary defect detecting device detects a severe defect by determining, based on the data of a brightness histogram generated from all pixel data in the inspecting region and a threshold set in a threshold setting process, whether or not a frequency of each class of the histogram is within a frequency range defined by the threshold.

6. The defect detection apparatus according to claim 2, further comprising a pixel count reducing device for reducing a pixel count of the image data of the non-defective product and image data of the inspection object,
wherein the primary defect detecting device detects a severe defect on the inspection object by comparing the image data of the non-defective product with reduced pixel count with the image data of the inspection object.

7. The defect detection apparatus according to claim 6, wherein the primary defect detecting device compares, for each pixel, the image data of the non-defective product with reduced pixel count with the image data of the inspection object, and detects a severe defect and a position thereof on the inspection object based on the comparison result of each pixel.

8. The defect detection apparatus according to claim 6, further comprising a memory device for storing area position information representing positions of multiple inspecting areas,
wherein the primary defect detecting device compares, for each pixel, the image data of the non-defective product with reduced pixel count with the image data of the inspection object, and detects a severe defect on the inspection object for each inspection area based on the comparison result of each pixel and the area information.

9. The defect detection apparatus according to claim 8, wherein the inspection object is a semiconductor wafer, and the multiple inspection areas includes at least one of a chip area, a scribe area, an extra area, and an edge cut area of the semiconductor wafer.

10. The defect detection apparatus according to claim 6, wherein the image data of the non-defective product and the image data of the inspection object are used to compare the brightness values thereof.

11. A defect detection method for performing a primary defect detection process for detecting a severe defect of more than a predetermined size on an inspection object, and a secondary defect detection process for detecting a defect on the inspection object using image data of the inspection object,
wherein the secondary defect detection process is omitted upon detection of the severe defect in the primary defect detection process before starting the secondary defect detection process, or the secondary defect detection process is stopped upon detection of the severe defect in the primary defect detection process after starting the secondary defect detection process.
